(19) United States
(12) Patent Application Publication
(10) Pub. No.: US 2026/0197686 A1
(43) Pub. Date: Jul. 9, 2026

(54) INFORMATION TRANSMISSION METHOD AND APPARATUS

(71) Applicant: HUAWEI TECHNOLOGIES CO., LTD., Shenzhen (CN)

(72) Inventors: Chen Xu, Hangzhou (CN); Gongzheng Zhang, Hangzhou (CN); Jian Wang, Hangzhou (CN); Rong Li, Shanghai (CN)

(21) Appl. No.: 19/557,749

(22) Filed: Mar. 5, 2026

Related U.S. Application Data
(63) Continuation of application No. PCT/CN2023/117569, filed on Sep. 7, 2023.

(51) Int. Cl. H04W 24/08

(52) U.S. Cl. CPC H04W 24/08

(57) ABSTRACT

An information transmission method includes receiving first information from a first apparatus. The first information indicates a first model for performing local data processing and a second model for performing global data processing. The information transmission method also includes receiving an output signal from the first apparatus. The output signal is obtained by the first apparatus by processing first data through the first model and the second model. The information transmission method further includes processing the output signal based on the first model and the second model to obtain second data.

### CROSS-REFERENCE TO RELATED APPLICATIONS

This application is a continuation of International Application No. PCT/CN2023/117569, filed on Sep. 7, 2023, the disclosure of which is hereby incorporated by reference in its entirety.

### TECHNICAL FIELD

This application relates to the field of wireless communication technologies, and in particular, to an information transmission method and an apparatus.

### BACKGROUND

Artificial intelligence technologies have been successfully applied in fields of image processing and natural language processing, and increasingly mature artificial intelligence technologies will play an important role in promoting evolution of mobile communication network technologies. Currently, the artificial intelligence technologies are mainly applied to a network layer, a physical layer, and the like.

The artificial intelligence technologies applied to the physical layer are mostly used to replace modules at the physical layer, for example, modules for signal processing such as encoding, modulation, multiple input multiple output precoding, and beamforming. Main advantages of the artificial intelligence technologies are reducing a computation delay, improving algorithm performance, and the like. However, for the modules at the physical layer, performance achieved by an independent optimization algorithm of each module is already close to an upper bound of performance, leaving limited gains to be achieved through only module replacement.

To ensure good performance of a receiver, a plurality of modules may be jointly optimized, and an artificial intelligence (AI) model may be designed, to process a received signal through the AI model. However, in a wireless network, differences in channel conditions significantly affect performance of the AI model, affecting performance of the receiver. Therefore, it is difficult for a terminal to determine an AI model to be used for receiving a signal.

### SUMMARY

This application provides an information transmission method and an apparatus, to determine models used by a receiver and a transmitter.

According to a first aspect, an information transmission method is provided, and the method may be performed by a second apparatus. The second apparatus may be a terminal device, a network device, or a chip/chip system. In the method, a second apparatus receives first information from a first apparatus, where the first information indicates a first model for performing local data processing and a second model for performing global data processing. The second apparatus may further receive an output signal from the first apparatus. It may be understood that the output signal is a signal obtained by the first apparatus by processing first data through the first model and the second model. The second apparatus processes the output signal based on the first model and the second model to obtain second data.

According to this solution, the first apparatus may determine the first model and the second model that are used for data processing, and indicate the first model and the second model to the second apparatus. In this way, the second apparatus may determine, based on the indication of the first apparatus, to process the signal through the first model and the second model, to improve performance of a receiver.

In a possible implementation, the second apparatus receives a downlink reference signal from the first apparatus, and measures the downlink reference signal to obtain measurement information of the downlink reference signal. The measurement information of the downlink reference signal is used to determine the first model and the second model. The second apparatus sends the measurement information of the downlink reference signal to the first apparatus.

According to this solution, the second apparatus may measure the downlink reference signal, determine the measurement information of the downlink reference signal, and report the measurement information of the downlink reference signal to the first apparatus. In this way, the first apparatus may determine a channel status based on the measurement information of the downlink reference signal, to determine to select the first model and the second model for data processing.

In a possible implementation, the second apparatus sends an uplink reference signal to the first apparatus, where the uplink reference signal is used by the first apparatus to measure the uplink reference signal, to obtain measurement information of the uplink reference signal. The measurement information of the uplink reference signal is used to determine the first model and the second model.

According to this solution, the second apparatus may send the uplink reference signal to the first apparatus, to be used by the first apparatus to perform measurement. In this way, the first apparatus may determine the channel status, to determine to select the first model and the second model for data processing.

In a possible implementation, the first information indicates an index of one or more first models, and the first information further indicates an index of the second model. According to this solution, the first information may indicate the index of the first model and the index of the second model, and occupy a small quantity of bits.

In a possible implementation, the first information includes an antenna port field and a channel characteristic indication field. The antenna port field and the channel characteristic field may indicate the first model and the second model. It may be understood that, in a related technology, the antenna port field indicates an antenna port number, and the channel characteristic indication field indicates a channel characteristic. According to this solution, an existing field may be reused for the first information.

In a possible implementation, the second apparatus inputs the output signal to an input layer of a neural network for dimension increase processing to obtain N1 high-dimensional vectors. The second apparatus processes the N1 high-dimensional vectors through the first model, to obtain N2 high-dimensional vectors. A manner of processing the N1 high-dimensional vectors through the first model is pre-trained. The second apparatus processes the N2 high-dimensional vectors through the second model, to obtain N3 high-dimensional vectors. A manner of processing the N2 high-dimensional vectors through the second model is pre-trained. The second apparatus inputs the N3 high-dimensional vectors to an output layer of the neural network to obtain the second data.

According to the foregoing solution, the first model and the second model are used to optimize the N1 high-dimensional vectors obtained based on the input signal. Because optimization of the high-dimensional vector through the first model and the second model is independent of a dimension of the vector, signal processing complexity can be reduced. In addition, quantities of high-dimensional vectors input to the first model and the second model may change, so that scalability of signals in different dimensions can be implemented.

In a possible implementation, the second apparatus may input an output signal corresponding to M data streams to the input layer for dimension increase processing, to obtain the N1 high-dimensional vectors. One high-dimensional vector corresponds to one data stream.

According to this solution, local data is processed through the first model, so that the neural network provided in this application can be applied to a multiple input multiple output (MIMO) scenario, to process the data stream.

In a possible implementation, the output signal includes data received by a communication apparatus, and the second data includes a log-likelihood ratio. According to the foregoing solution, when the output signal includes data received by the second apparatus, and the second data includes a log-likelihood ratio of the data, the second apparatus may decode the received data based on the log-likelihood ratio.

In a possible implementation, the first information further indicates whether the output signal includes a demodulation reference signal (DMRS). According to this solution, the first information may indicate whether the output signal includes the DMRS, so that the second apparatus determines whether channel estimation and channel equalization need to be performed based on the DMRS.

In a possible implementation, the first information further indicates a quantity of transmit streams of the output signal. According to this solution, the first information may indicate the quantity of transmit streams, so that the second apparatus can determine a quantity of data streams.

According to a second aspect, an information transmission method is provided, and the method may be performed by a first apparatus. The first apparatus may be a network device, a terminal device, or a chip/chip system. In the method, the first apparatus sends first information to a second apparatus, where the first information indicates a first model for performing local data processing and a second model for performing global data processing. The first apparatus processes first data based on the first model and the second model to obtain an output signal. The first apparatus sends the output signal to the second apparatus.

In a possible implementation, the first apparatus sends a downlink reference signal to the second apparatus. The first apparatus receives measurement information of the downlink reference signal from the second apparatus. The measurement information of the downlink reference signal is measured by the second apparatus based on the downlink reference signal, and the measurement information of the downlink reference signal is used to determine the first model and the second model.

In a possible implementation, the first apparatus receives an uplink reference signal from the second apparatus. The first apparatus measures the uplink reference signal to obtain measurement information of the uplink reference signal, where the measurement information of the uplink reference signal is used to determine the first model and the second model.

In a possible implementation, the first information indicates an index of one or more first models, and the first information further indicates an index of the second model.

In a possible implementation, the first information includes an antenna port field and a channel characteristic indication field. The antenna port field and the channel characteristic field may indicate the first model and the second model. It may be understood that, in a related technology, the antenna port field indicates an antenna port number, and the channel characteristic indication field indicates a channel characteristic.

In a possible implementation, the first apparatus inputs the first data to an input layer of a neural network for dimension increase processing to obtain N1 high-dimensional vectors. The second apparatus processes the N1 high-dimensional vectors through the first model, to obtain N2 high-dimensional vectors. A manner of processing the N1 high-dimensional vectors through the first model is pre-trained. The second apparatus processes the N2 high-dimensional vectors through the second model, to obtain N3 high-dimensional vectors. A manner of processing the N2 high-dimensional vectors through the second model is pre-trained. The second apparatus inputs the N3 high-dimensional vectors to an output layer of the neural network to obtain the output signal.

In a possible implementation, the first apparatus may input an output signal corresponding to M data streams to the input layer for dimension increase processing, to obtain the N1 high-dimensional vectors. One high-dimensional vector corresponds to one data stream.

In a possible implementation, the first data includes a modulation symbol, and the output signal includes a transmission symbol. It may be understood that a waveform may be generated when the transmission symbol passes through a waveform generation module. The first apparatus may transmit, through an antenna, a signal corresponding to the waveform. According to the foregoing solution, when the neural network is applied to a transmitter, the first data includes the modulation symbol, and the output signal includes the transmission symbol, so that the first apparatus can implement aliasing of modulation symbols, and the transmitter can adapt to a channel.

In a possible implementation, the first data includes a to-be-encoded bit, and the output signal includes an encoded bit or a transmission symbol. According to the foregoing solution, when the first data includes the to-be-encoded bit and the output signal includes the encoded bit, the first apparatus may encode the to-be-encoded bit based on the foregoing neural network. When the first data includes the to-be-encoded bit and the output signal includes the transmission symbol, the first apparatus may map the to-be-encoded bit to the transmission symbol based on the neural network.

In a possible implementation, the first information further indicates whether the output signal includes a DMRS.

In a possible implementation, the first information further indicates a quantity of transmit streams of the output signal.

According to a third aspect, a communication apparatus is provided, including a processing unit and a transceiver unit.

The transceiver unit is configured to receive first information from a first apparatus, where the first information indicates a first model for performing local data processing and a second model for performing global data processing. The transceiver unit is further configured to receive an output signal from the first apparatus. The output signal is a signal obtained by the first apparatus by processing the first data through the first model and the second model. The processing unit is configured to process the output signal based on the first model and the second model to obtain second data.

In a possible implementation, the transceiver unit is further configured to receive a downlink reference signal from the first apparatus. The processing unit is further configured to measure the downlink reference signal to obtain measurement information of the downlink reference signal. The measurement information of the downlink reference signal is used to determine the first model and the second model. The transceiver unit is further configured to send the measurement information of the downlink reference signal to the first apparatus.

In a possible implementation, the transceiver unit is further configured to send an uplink reference signal to the first apparatus, where the uplink reference signal is used by the first apparatus to measure the uplink reference signal, to obtain measurement information of the uplink reference signal. The measurement information of the uplink reference signal is used to determine the first model and the second model.

In a possible implementation, the first information indicates an index of one or more first models, and the first information further indicates an index of the second model.

In a possible implementation, the first information includes an antenna port field and a channel characteristic indication field. The antenna port field and the channel characteristic field may indicate the first model and the second model. It may be understood that, in a related technology, the antenna port field indicates an antenna port number, and the channel characteristic indication field indicates a channel characteristic.

In a possible implementation, the processing unit is configured to input the output signal to an input layer of the neural network for dimension increase processing to obtain N1 high-dimensional vectors. The processing unit is configured to process the N1 high-dimensional vectors through the first model to obtain N2 high-dimensional vectors. A manner of processing the N1 high-dimensional vectors through the first model is pre-trained. The processing unit is configured to process the N2 high-dimensional vectors through the second model, to obtain N3 high-dimensional vectors. A manner of processing the N2 high-dimensional vectors through the second model is pre-trained. The processing unit is configured to input the N3 high-dimensional vectors to an output layer of the neural network to obtain the second data.

In a possible implementation, the processing unit is configured to input an output signal corresponding to M data streams to the input layer for dimension increase processing, to obtain the N1 high-dimensional vectors. One high-dimensional vector corresponds to one data stream.

In a possible implementation, the output signal includes a modulation symbol, a waveform signal, an air interface data symbol, an air interface pilot symbol, or a filtered air interface symbol.

In a possible implementation, the second data includes a channel estimation result, a channel equalization weight, noise power, a log-likelihood ratio, or a decoded bit.

In a possible implementation, the first information further indicates whether the output signal includes a DMRS.

In a possible implementation, the first information further indicates a quantity of transmit streams of the output signal.

According to a fourth aspect, a communication apparatus is provided, including a processing unit and a transceiver unit.

The transceiver unit is configured to send first information to a second apparatus, where the first information indicates a first model for performing local data processing and a second model for performing global data processing. The processing unit is configured to process first data based on the first model and the second model to obtain an output signal. The transceiver unit is further configured to send the output signal to the second apparatus.

In a possible implementation, the transceiver unit is further configured to send a downlink reference signal to the second apparatus. The transceiver unit is further configured to receive measurement information of the downlink reference signal from the second apparatus. The measurement information of the downlink reference signal is measured by the second apparatus based on the downlink reference signal, and the measurement information of the downlink reference signal is used to determine the first model and the second model.

In a possible implementation, the transceiver unit is further configured to receive an uplink reference signal from the second apparatus. The processing unit is further configured to measure the uplink reference signal to obtain measurement information of the uplink reference signal, where the measurement information of the uplink reference signal is used to determine the first model and the second model.

In a possible implementation, the first information indicates an index of one or more first models, and the first information further indicates an index of the second model.

In a possible implementation, the first information includes an antenna port field and a channel characteristic indication field. The antenna port field and the channel characteristic field may indicate the first model and the second model. It may be understood that, in a related technology, the antenna port field indicates an antenna port number, and the channel characteristic indication field indicates a channel characteristic.

In a possible implementation, the processing unit is configured to input the first data to an input layer of a neural network for dimension increase processing to obtain N1 high-dimensional vectors. The processing unit is configured to process the N1 high-dimensional vectors through the first model to obtain N2 high-dimensional vectors. A manner of processing the N1 high-dimensional vectors through the first model is pre-trained. The processing unit is configured to process the N2 high-dimensional vectors through the second model, to obtain N3 high-dimensional vectors. A manner of processing the N2 high-dimensional vectors through the second model is pre-trained. The processing unit is configured to input the N3 high-dimensional vectors to an output layer of the neural network to obtain the output signal.

In a possible implementation, the first apparatus may input an output signal corresponding to M data streams to the input layer for dimension increase processing, to obtain the N1 high-dimensional vectors. One high-dimensional vector corresponds to one data stream.

In a possible implementation, the first data includes an unencoded bit, an encoded bit, or a modulation symbol.

In a possible implementation, the output signal includes a modulation symbol or a waveform signal.

In a possible implementation, the first information further indicates whether the output signal includes a DMRS.

In a possible implementation, the first information further indicates a quantity of transmit streams of the output signal.

According to a fifth aspect, this application provides a communication apparatus, including a processor. The processor is coupled to a memory. The memory is configured to store a computer program or instructions. The processor is configured to execute the computer program or the instructions, to perform the implementation methods in the first aspect and the second aspect. The memory may be located inside or outside the apparatus. There is one or more processors.

According to a sixth aspect, this application provides a communication apparatus, including a processor and an interface circuit. The interface circuit is configured to communicate with another apparatus, and the processor is configured to perform the implementation methods in the first aspect and the second aspect.

According to a seventh aspect, a communication apparatus is provided. The apparatus includes a logic circuit and an input/output interface.

According to an eighth aspect, this application provides a communication system, including a terminal device and a network device that are configured to perform the implementation methods of the first aspect and the second aspect.

According to a ninth aspect, this application further provides a chip system, including a processor configured to perform the implementation methods in the first aspect and the second aspect.

According to a tenth aspect, this application further provides a computer program product, including a computer program or instructions. When the computer program or the instructions are run on a computer, the implementation methods in the first aspect and the second aspect are performed.

According to an eleventh aspect, this application further provides a computer-readable storage medium. The computer-readable storage medium stores a computer program or instructions. When the instructions are run on a computer, the implementation methods in the first aspect and the second aspect are implemented.

For technical effects achieved in the second aspect to the eleventh aspect, refer to the technical effects in the first aspect. Details are not described herein again.

### BRIEF DESCRIPTION OF DRAWINGS

FIG. 1 is a diagram of a communication system according to an embodiment of this application;

FIG. 2 is a diagram of a signal processing method of a receiver based on a convolutional neural network structure according to an embodiment of this application;

FIG. 3 is an example flowchart of a signal processing method according to an embodiment of this application;

FIG. 4 is a diagram of a neural network according to an embodiment of this application;

FIG. 5A is a diagram of a processing layer of a neural network according to an embodiment of this application;

FIG. 5B is a diagram of a processing layer of a neural network according to an embodiment of this application;

FIG. 5C is a diagram of a processing layer of a neural network according to an embodiment of this application;

FIG. 5D is a diagram of a processing layer of a neural network according to an embodiment of this application;

FIG. 6 is a diagram of a processing layer of a neural network according to an embodiment of this application;

FIG. 7A is a diagram of a second model of a neural network according to an embodiment of this application;

FIG. 7B is a diagram of a first matrix according to an embodiment of this application;

FIG. 7C is a diagram of a first model according to an embodiment of this application;

FIG. 8 is a diagram of a processing layer of a neural network according to an embodiment of this application;

FIG. 9 is a diagram of a processing layer of a neural network according to an embodiment of this application;

FIG. 10 is an example flowchart of an information transmission method according to an embodiment of this application;

FIG. 11 is a diagram of a DMRS according to an embodiment of this application;

FIG. 12 is an example flowchart of an information transmission method according to an embodiment of this application;

FIG. 13 is a diagram of a communication apparatus according to an embodiment of this application;

FIG. 14 is a diagram of a communication apparatus according to an embodiment of this application;

FIG. 15 is a diagram of a communication apparatus according to an embodiment of this application; and

FIG. 16 is a diagram of a communication apparatus according to an embodiment of this application.

### DESCRIPTION OF EMBODIMENTS

Technical solutions in embodiments of this application may be applied to a new radio (NR) system, a long term evolution (LTE) system, an LTE frequency division duplex (FDD) system, an LTE time division duplex (TDD) system, a worldwide interoperability for microwave access (WiMAX) communication system, and the like. This is not limited herein.

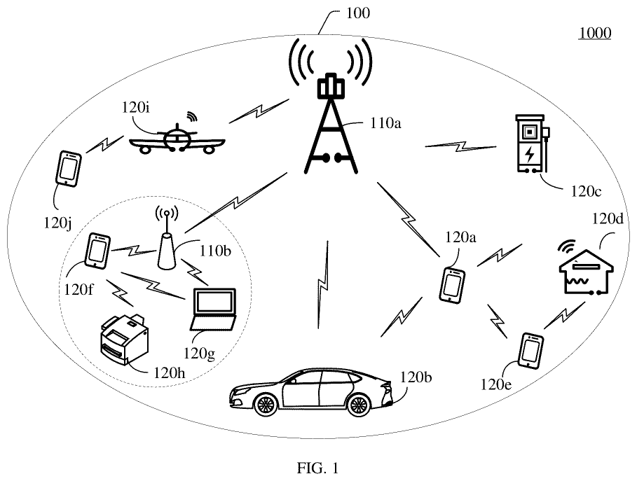

FIG. 1 is a diagram of an architecture of a communication system 1000 to which embodiments of this application are applied. As shown in FIG. 1, the communication system includes a radio access network 100. The radio access network 100 may include at least one network device (for example, 110a and/or 110b in FIG. 1), and may further include at least one terminal apparatus (for example, at least one of 120a to 120j in FIG. 1). The terminal apparatus is connected to an access network device in a wireless manner, and the access network device is connected to a core network device in a wireless or wired manner. Terminal apparatuses may be connected to each other in a wired or wireless manner, and network devices may be connected to each other in a wired or wireless manner. FIG. 1 is merely a diagram. The communication system may further include another network device, for example, may further include a wireless relay device and a wireless backhaul device, which are not shown in FIG. 1.

The network device is a network-side device having a wireless transceiver function. The network device may be an apparatus that is in a radio access network (RAN) and that provides a wireless communication function for the terminal device, and is referred to as a RAN device. For example, the network device may be a base station, an evolved NodeB (eNodeB), a transmission reception point (transmission and reception point, TRP), a next generation NodeB (gNB) in a 5th generation (5G) mobile communication system, a next generation base station in a 6th generation (6G) mobile communication system, a base station in a future mobile communication system, an access node in a Wi-Fi system, or the like; or may be a module or a unit that completes a part of functions of the base station, for example, may be a central unit (CU) or a distributed unit (DU). The CU herein completes functions of a radio resource control protocol and a packet data convergence protocol (PDCP) of the base station, and may further complete functions of a service data adaptation protocol (SDAP). The DU completes functions of a radio link control layer and a medium access control (MAC) layer of the base station, and may further complete functions of some physical layers or all physical layers. For example descriptions of the foregoing protocol layers, refer to technical specifications related to the 3rd generation partnership project (3GPP). The network device may be a macro base station (for example, 110a in FIG. 1), may be a micro base station or an indoor base station (for example, 110b in FIG. 1), or may be a relay node, a donor node, or the like. A specific technology and a specific device form that are used by the network device are not limited in embodiments of this application. In this embodiment of this application, an example in which the network device is a base station is used for description.

In another possible scenario, a plurality of RAN nodes cooperate to assist the terminal in implementing radio access, and different RAN nodes separately implement a part of functions of the base station. For example, the RAN node may be a CU, a DU, a CU-control plane (CU-CP), a CU-user plane (CU-UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any unit of the CU (or the CU-CP or the CU-UP), the DU, and the RU in this application may be implemented by using a software module, a hardware module, or a combination of a software module and a hardware module.

The terminal device is a user-side device having a wireless transceiver function. The terminal device may also be referred to as user equipment (UE), a mobile station, a mobile terminal, or the like. The terminal apparatus may be widely used in various scenarios such as device-to-device (D2D), vehicle to everything (V2X) communication, machine-type communication (MTC), an internet of things (IoT), virtual reality, augmented reality, industrial control, autonomous driving, telemedicine, a smart grid, smart furniture, a smart office, a smart wearable, smart transportation, and a smart city. The terminal apparatus may be a mobile phone, a tablet computer, a computer having a wireless transceiver function, a wearable device, a vehicle, an uncrewed aerial vehicle, a helicopter, an airplane, a ship, a robot, a robotic arm, a smart home device, or the like. A specific technology and a specific apparatus form that are used by the terminal apparatus are not limited in embodiments of this application. In this embodiment of this application, an example in which the terminal device is a terminal is used for description.

The network device and the terminal device may be at fixed locations, or may be movable. The network device and the terminal device may be deployed on the land, including an indoor device, an outdoor device, a handheld device, or a vehicle-mounted device; may be deployed on a water surface; or may be deployed on a plane, a balloon, and an artificial satellite in the air. Application scenarios of the network device and the terminal device are not limited in embodiments of this application.

Roles of the network device and the terminal device may be relative. For example, a helicopter or an uncrewed aerial vehicle 120i in FIG. 1 may be configured as a mobile network device. For the terminal device 120j that accesses the radio access network 100 via 120i, the terminal device 120i is a network device. However, for the network device 110a, 120i is a terminal device. That is, 110a and 120i communicate with each other according to a wireless air interface protocol. Certainly, 110a and 120i may alternatively communicate with each other according to an interface protocol between network devices. In this case, compared with 110a, 120i is also a network device. Therefore, both the network device and the terminal device may be collectively referred to as communication apparatuses. 110a and 110b in FIG. 1 may be referred to as communication apparatuses having a function of a network device, and 120a to 120j in FIG. 1 may be referred to as communication apparatuses having a function of a terminal device.

In this embodiment of this application, the function of the network device may alternatively be performed by a module (for example, a chip) in the network device, or may be performed by a control subsystem including the function of the network device. The control subsystem including the function of the network device may be a control center in the foregoing application scenarios such as a smart grid, industrial control, intelligent transportation, and a smart city. The function of the terminal device may alternatively be performed by a module (for example, a chip or a modem) in the terminal device, or may be performed by an apparatus including the function of the terminal device.

In this embodiment of this application, an apparatus configured to implement the function of the terminal device may be a terminal device, or may be an apparatus that can support a terminal device in implementing the function, for example, a chip system. The apparatus may be mounted in the terminal device or may be matched with the terminal device for use. In this embodiment of this application, the chip system may include a chip, or may include a chip and another discrete component.

In this embodiment of this application, an apparatus configured to implement the function of the network device may be a network device, or may be an apparatus that can support a network device in implementing the function, for example, a chip system. The apparatus may be mounted in the network device or may be matched with the network device for use.

In this embodiment of this application, the terminal device may further have an AI processing capability, and the network device may also have an AI processing capability. For example, the terminal device may have a training capability, an inference capability, and the like of a neural network. Optionally, the network device may also have a training capability, an inference capability, and the like of a neural network.

Artificial intelligence technologies have been successfully applied in fields of image processing and natural language processing, and increasingly mature artificial intelligence technologies will play an important role in promoting evolution of mobile communication network technologies. Currently, the artificial intelligence technologies are mainly applied to a network layer, a physical layer, and the like.

The artificial intelligence technologies applied to the physical layer are mostly used to replace modules at the physical layer, for example, modules for signal processing. Main advantages of the artificial intelligence technologies are reducing a computation delay, improving algorithm performance, and the like. However, for the modules at the physical layer, performance achieved by an independent optimization algorithm of each module is already close to an upper bound of performance, leaving limited gains to be achieved through only module replacement. Therefore, performing joint optimization on a plurality of modules is a manner of improving joint performance of the plurality of modules, and is also done well by using the artificial intelligence technologies, for example, jointly designing a receiver by using the artificial intelligence technologies.

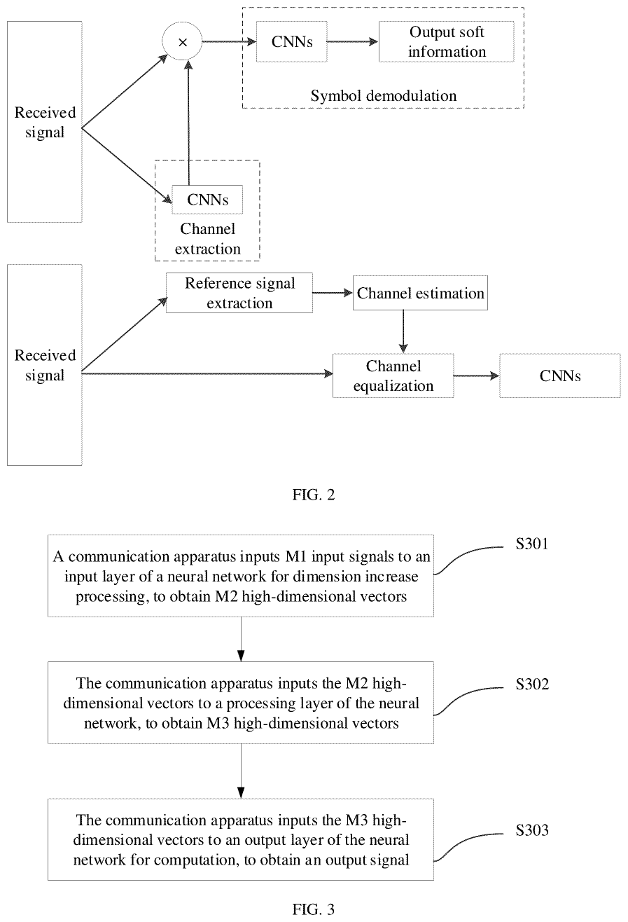

In a possible implementation, the receiver may be designed in a structure of a convolutional neural network (CNN), as shown in FIG. 2. CNNs in FIG. 2 may represent a plurality of layers of convolutional neural networks. It can be learned that a design of the structure of the convolutional neural network still follows a current receiver structure, and is mainly used for channel estimation, equalization, demodulation, and the like. However, a range of correlations that can be extracted by the CNN is limited, and usually, only a part can be extracted, for example, a correlation between adjacent signal patches. Therefore, main disadvantages of designing the receiver in the structure of the CNN are that a quantity of parameters of the CNN is small, and generalization performance of a convolution operation principle is poor in different scenarios. For example, it is difficult for a complex frequency selective channel to have good performance even if the convolutional neural network is used for designing the receiver in a multiple input multiple output (MIMO) scenario.

To ensure good performance of the receiver, the plurality of modules may be jointly optimized, and an AI model may be designed, to process a received signal through the AI model. However, in a wireless network, differences in channel conditions significantly affect performance of the AI model, which affects performance of the receiver. Therefore, it is difficult for a terminal to determine an AI model to be used for receiving a signal.

It may be understood that the technical solutions provided in embodiments of this application may be applied to a first apparatus and a second apparatus. The first apparatus may be a terminal device or a network device. Similarly, the second apparatus may be a terminal device or a network device. For example, when the first apparatus is a terminal device, the second apparatus may be a terminal device or a network device. For another example, when the first apparatus is a network device, the second apparatus may be a terminal device or a network device. In the following, an example in which the first apparatus is a network device such as a base station, and the second apparatus is a terminal device such as a terminal is used for description.

In view of this, embodiments of this application provide an information transmission method. In the method, a terminal may receive first information from a base station, where the first information may indicate a first model for performing local data processing on a data stream and a second model for performing global data processing on the data stream. In this way, the terminal may process, through the first model and the second model, an output signal received from the base station, to obtain second data. According to this solution, the base station may determine the first model and the second model that are used for data processing, and indicate the first model and the second model to the terminal. In this way, the terminal may determine to process the signal through the first model and the second model, to improve performance of a receiver.

For ease of understanding the technical solutions provided in embodiments of this application, the following describes the first model and the second model. The first model may be configured to perform local data processing. For example, the local data processing may include processing one or more symbols, such as one or more orthogonal frequency division multiplexing (OFDM) symbols, processing one or more data streams, processing one or more resource block groups (RBGs), processing one or more RBG bundles, processing one or more control channel elements (CCEs), processing one or more aggregation levels, processing one or more search space, processing one or more control resource sets (CORESETs), or processing one or more CORESET combinations (where one CORESET combination includes one or more CORESETS).

The second model provided in embodiments of this application may be configured to perform global data processing. For example, the global data processing may include processing all input data, for example, jointly processing an output of the first model. Optionally, the first model may process local data, and the second model may process global data.

In embodiments of this application, the base station may input data, such as an unencoded bit and an encoded bit, to the first model and the second model, to obtain the output signal, such as a modulation symbol or a waveform symbol. Similarly, a transmitter and a receiver may have a same structure. The terminal may input, to the first model and the second model, the signal received from the base station, such as an unprocessed signal, a processed modulation symbol, a waveform signal, an air interface data symbol, an air interface pilot symbol, or a filtered air interface symbol, to obtain the second data, such as a channel estimation result, a channel equalization weight, noise power, a log-likelihood ratio, or a decoded bit.

The following describes data processing manners of the base station and the terminal in embodiments of this application with reference to FIG. 3. A manner shown in FIG. 3 may be applied to a communication apparatus, such as a terminal or a base station. The method is applicable to a receiving end, or may be applicable only to a transmitting end. FIG. 3 is an example flowchart of signal processing performed by a base station or a terminal according to an embodiment of this application. The following operations may be included.
S301: Input M1 input signals to an input layer of a neural network for dimension increase processing, to obtain M2 high-dimensional vectors, where M2 is a positive integer. It may be understood that M2 herein may be the same as or different from M1, and M2 may be greater than M1 or may be less than M1.

It may be understood that the input signal in S301 may be a received signal, for example, a signal received from the base station. Alternatively, the input signal in S301 may be a signal obtained from a higher layer, for example, a physical layer, of a communication apparatus. For example, when the method is applied to a transmitting end, the input signal may be a bit, a symbol, or the like. For example, when the method is applied to a receiving end, the input signal may be a symbol received at the receiving end; or the input signal may be an input signal representing a probability, such as a log-likelihood ratio of a symbol.

In S301, the input layer of the neural network may perform dimension increase processing on the input signal to obtain the high-dimensional vector. For example, the input layer of the neural network may increase a 16-dimensional input signal to 256 dimensions. In the following, for ease of description, a dimension of the high-dimensional vector is described as dₖ, where dₖ is a positive integer.
S302: Input the M2 high-dimensional vectors to a processing layer of the neural network, to obtain M3 high-dimensional vectors.

The processing layer of the neural network may include a first model and a second model.

In a possible implementation, the processing layer of the neural network may be configured to process the high-dimensional vector. For example, the first model may be configured to optimize one high-dimensional vector, and the second model may be configured to optimize a plurality of high-dimensional vectors based on a relationship between the plurality of high-dimensional vectors. It may be understood that a manner of processing the high-dimensional vector by the first model and a manner in which of processing the high-dimensional vector by the second model are pre-trained.

For example, the first model and the second model may be trained based on a loss function. When the first model and the second model are applied to different scenarios, loss functions may be different. For example, for training of reducing a peak to average power ratio (PAPR) of a transmitter, neural networks on a transmitting side and a receiving side may be jointly trained, or training may be completed only on a transmitter side. Single-side training is used as an example. A loss function in this case may be a ratio of a maximum value to an average value of an output signal of the transmitter, and a training objective is to minimize the loss function. Therefore, after training is completed, a function of the first model may be understood as reducing a PAPR of a local transmitted signal, in other words, reducing the PAPR of the local transmitted signal in a high-dimensional space, which may be reducing a PAPR of an intra-stream transmitted signal for a MIMO scenario. A function of the second model may be understood as reducing a difference between a maximum value and an average value of a global output signal, in other words, reducing the difference between the maximum value and the average value of the global output signals in a high-dimensional space, which may be reducing differences between maximum values and average values of output signals of different streams for the MIMO scenario.

For another example, a bit error rate is reduced. For example, joint training is performed on both the transmitting side and the receiving side. A loss function for training is a cross entropy between an input symbol/bit and an output log-likelihood ratio (LLR)/bit, which is equivalent to maximizing mutual information of a system input and a system output. A function of a first model of the transmitter is to increase a distance between different local data in frequency domain and time domain, for example, a distance between different symbols. A function of a first model of a receiver is to distinguish between local data to a greatest extent, for example, distinguish between different symbols, jointly with the first model of the transmitter. A function of a second model of the transmitter is to further increase the distance between different local data, for example, the distance between different symbols, in combination with a spatial characteristic of a channel, and a function of a second model of the receiver is to perform interference cancellation on and distinguish between the local data in space domain, for example, perform interference cancellation on and distinguish between symbol streams.
S303: Input the M3 high-dimensional vectors to an output layer of the neural network for computation, to obtain an output signal.

In S303, the output layer of the neural network may perform computation based on the M3 high-dimensional vectors, to obtain the output signal. It may be understood that an operation of the output layer of the neural network varies with a scenario. For example, in a channel decoding scenario, the operation of the output layer of the neural network may be obtaining a log-likelihood ratio based on the M3 high-dimensional vectors. In other words, the output signal is the log-likelihood ratio. For another example, in a channel encoding scenario, the output layer of the neural network may obtain an encoded code block based on the M3 high-dimensional vectors. In other words, the output signal is the encoded code block. For another example, when the input signal in S301 is a log-likelihood ratio of a symbol, the corresponding output signal may be a bit sequence.

Optionally, in S303, the output layer of the neural network may further perform dimension reduction on the M3 high-dimensional vectors, and obtain the output signal based on the M3 high-dimensional vectors obtained through dimension reduction.

In the following, for ease of description, M1, M2, and M3 are set to N.

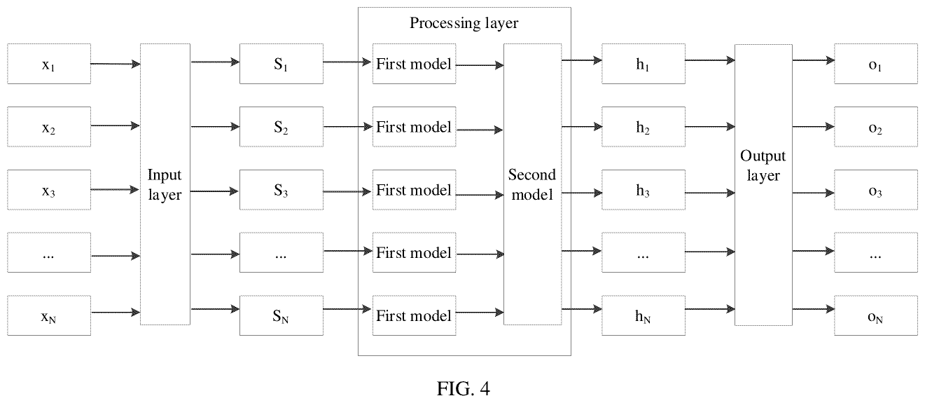

Refer to FIG. 4. A structure of a neural network according to an embodiment of this application is described. FIG. 4 is an example diagram of a structure of a neural network according to an embodiment of this application. It may be understood that FIG. 4 is merely used as an example of the structure of the neural network, and cannot constitute a limitation on the structure of the neural network. A person skilled in the art may design, based on the neural network shown in FIG. 4, another neural network used for signal processing, to implement the operations shown in FIG. 3.

As shown in FIG. 4, inputs of an input layer are input signals x, which are x₁ to x_{N}. The input layer performs dimension increase processing on the N input signals to obtain N high-dimensional vectors S, which are S₁ to S_{N}. A dimension of each high-dimensional vector is dₖ. In other words, a dimension of an output of the input layer is N×dₖ. An input of a processing layer is the output of the input layer, and the processing layer may be configured to process S₁ to S_{N}. It may be understood that processing on the high-dimensional vector may be considered as an operation performed by the processing layer in a dimension dₖ in the N×dₖ dimension. Therefore, the output of the processing layer is also (N×dₖ)-dimensional. N high-dimensional vectors h₁ to h_{N} may be obtained through the processing layer. An input of an output layer is the output of the processing layer, and the output layer may obtain output/input signals o₀ to o_{N} based on h₁ to h_{N}.

It should be noted that a dimension of the input of the processing layer is the same as the dimension of the output of the processing layer. Therefore, a quantity of inputs of the processing layer is the same as a quantity of outputs of the processing layer. The input layer may increase or decrease a quantity of input signals that are input. Similarly, the output layer may also increase or decrease each input high-dimensional vector.

According to the foregoing solution, each input signal is processed through the processing layer. Because a processing process is independent of a dimension of the input signal, signal processing complexity can be reduced. In addition, a quantity of input signals input to the processing layer may change, so that scalability of signals in different dimensions can be implemented.

In a possible implementation, the processing layer may include at least one model group. The model group/may include a second model l_1 and one or more first models l_2. The second model l_1 may be configured to process the N high-dimensional vectors, and the one or more first models l_2 may be configured to separately process each high-dimensional vector.

In a possible case, the model group 1 may include one first model l_2. In other words, the N high-dimensional vectors may be processed through the same first model l_2. For example, in a MIMO scenario, the N high-dimensional vectors may correspond to one or more data streams, and one first model l_2 may process all the data streams. In another possible case, there may be a plurality of first models l_2. In other words, the N high-dimensional vectors may be processed through different first models l_2. For example, in the MIMO scenario, the N high-dimensional vectors may correspond to one data stream, and the data stream may be processed through the plurality of first models l_2. For example, each first model l_2 may process a part of one data stream. For another example, in the MIMO scenario, the N high-dimensional vectors may correspond to a plurality of data streams, and the plurality of data streams may be processed through the plurality of first models l_2. For example, each first model l_2 may process one data stream, or each first model l_2 may process a part of the plurality of data streams.

It may be understood that a sequence between a second model and one or more first models in each model group is not specifically limited. Because the dimension of the input of the processing layer is the same as the dimension of the output of the processing layer, L-layer iterations may be performed at the processing layer. In other words, there may be L groups of model groups connected to each other, to achieve an objective of performing L-layer iterations at the processing layer. l is an integer greater than or equal to 1 and less than L.

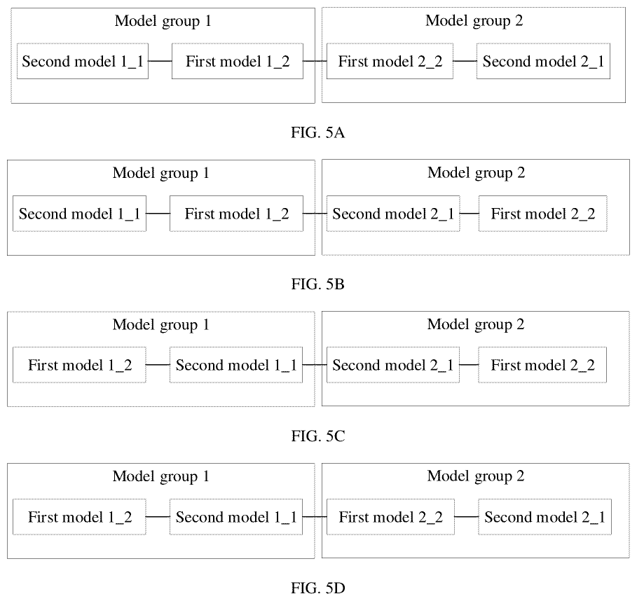

Refer to FIG. 5A. In a model group 1, a second model 1_1 is before one or more first models 1_2. In other words, an output of the second model 1_1 is used as an input of the one or more first models 1_2. In a model group 2, a second model 2_1 is after one or more first models 2_2. In other words, an output of the one or more first models 2_2 is used as an input of the second model 2_1. It can be learned from FIG. 5A that an input of the second model l_1 may be a high-dimensional vector, or may be an output of the one or more first models l_2. An input of the one or more first models l_2 may be an output of the second model l_1, or may be an output of one or more first models l-1_2.

Refer to FIG. 5B. In the model group 1, the second model 1_1 is before the one or more first models 1_2. In other words, the output of the second model 1_1 is used as the input of the one or more first models 1_2. In the model group 2, the second model 2_1 is before the one or more first models 2_2. In other words, an output of the second model 2_1 is used as an input of the one or more first models 2_2. It can be learned from FIG. 5B that the input of the second model l_1 may be a high-dimensional vector, or may be the output of the one or more first models l-1_2. The input of the one or more first models l_2 may be the output of the second model l_1.

Refer to FIG. 5C. In the model group 1, the second model 1_1 is after the one or more first models 1_2. In other words, an output of the one or more first models 1_2 is used as an input of the second model 1_1. In the model group 2, the second model 2_1 is before the one or more first models 2_2. In other words, the output of the second model 2_1 is used as the input of the one or more first models 2_2. It can be learned from FIG. 5C that the input of the second model l_1 may be the output of the one or more first models l_2, or may be an output of the second model l-1_1. The input of the one or more first models l_2 may be a high-dimensional vector, or may be the output of the second model l_1.

Refer to FIG. 5D. In the model group 1, the second model 1_1 is after the one or more first models 1_2. In other words, the output of the one or more first models 1_2 is used as the input of the second model 1_1. In the model group 2, the second model 2_1 is after the one or more first models 2_2. In other words, the output of the one or more first models 2_2 is used as the input of the second model 2_1. It can be learned from FIG. 5D that the input of the second model l_1 may be the output of the one or more first models l_2. The input of the one or more first models may be a high-dimensional vector, or may be the output of the second model l-1_1.

In a possible implementation, when a quantity of dimensions of the high-dimensional vector is greater than 2, for example, when a dimension of the high-dimensional vector is N×dₖ×y, the processing layer may further include a third model. The third model may be configured to process the high-dimensional vector in the dimension y, or the third model may be configured to perform a dimension transformation on the high-dimensional vector, for example, transform the high-dimensional vector from a three-dimensional vector into a two-dimensional vector. It may be understood that a sequence relationship between the third model, the second model, and the one or more first models may not be specifically limited. Refer to the foregoing implementation of the sequence relationship between the second model and the one or more first models.

According to the foregoing solution, multi-layer iterations at the processing layer are implemented via a plurality of model groups, so that a performance gain of the neural network can be obtained.

The processing layer mentioned in this embodiment of this application is further described below in Manner 1 to Manner 3.

### Manner 1:

The second model may refer to an operation of an attention layer, and the one or more first models may refer to an operation of a fully connected layer. In other words, operations of the processing layer may include the operation of the attention layer and the operation of the fully connected layer. The operation of the attention layer may satisfy Formula (1):

$$ATT ( Q , K , V ) = softmax ( \frac{Q {K}^{T}}{\sqrt{{d}_{k}}} ) V \qquad Formula ( 1 )$$

$${Q}_{N \times {d}_{k}} = {S}_{N \times {d}_{k}} {W}_{{d}_{k} \times {d}_{k}}^{Q} , {K}_{N \times {d}_{k}} = {S}_{N \times {d}_{k}} {W}_{{d}_{k} \times {d}_{k}}^{K} , {V}_{N \times {d}_{k}} = {S}_{N \times {d}_{k}} {W}_{{d}_{k} \times {d}_{k}}^{v} , {W}^{Q} , {W}^{K} ,$$

and W^{V} are trained parameters. S_{N×d}_{ₖ} represents an input of the attention layer, where N may be understood as a quantity of the high-dimensional vectors S, and dₖ represents the dimension of each high-dimensional vector S. ATT(Q, K, V) represents an output of the attention layer and represents a correlation between any two high-dimensional vectors. Q, K, and V represent results obtained by performing three linear transformations on the input S, Q represents a query vector, W^{Q} represents a weight of the query vector, K represents a key vector, W^{K} represents a weight of the key vector, V represents a value vector, and W^{V} represents a weight of the value vector. It can be learned that the input of the attention layer is (N×dₖ)-dimensional.

Optionally, if the attention layer is extended to a multi-head attention layer, W^{Q}, W^{K} and W^{V} each have a plurality of groups of values. It may be understood that parameters of attention layers of all the model groups may be different.

It should be noted that W^{Q}, W^{K}, and W^{V} may be trained in a gradient backpropagation manner. For example, initial parameters of W^{Q}, W^{K}, and W^{V} may be set to random numbers. In addition, the high-dimensional vector during training is processed through the attention layer, to obtain an output/input signal during training. A training gradient is obtained based on a known output/input signal and the output/input signal during training, and the gradient is backpropagated to the attention layer, to adjust W^{Q}, W^{K}, and W^{V}. In the foregoing training manner, W^{Q}, W^{K}, and W^{V} may be trained a plurality of times, to obtain trained W^{Q}, W^{K}, and W^{V}.

The fully connected layer performs an operation independently on each high-dimensional vector, and each high-dimensional vector shares parameters of the fully connected layer. The operation of the fully connected layer may satisfy Formula (2):

$$y = f ( x {W}^{M} + b ) \qquad Formula ( 2 )$$

y represents an output of the fully connected layer, x represents an input of the fully connected layer, and f represents an activation function. For example, the activation function may be one of a linear function, a pseudo-inverse function, an inverse function, a sigmoid function, a softmax function, a ReLU function, a GELU function, and the like. W^{M} represents a weight of the fully connected layer, and b represents a bias of the fully connected layer. W^{M} and b are trained parameters, and a training manner may be implemented with reference to the foregoing training manner of W^{Q}, W^{K}, and W^{V}. It may be understood that parameters of fully connected layers of all the model groups may be different.

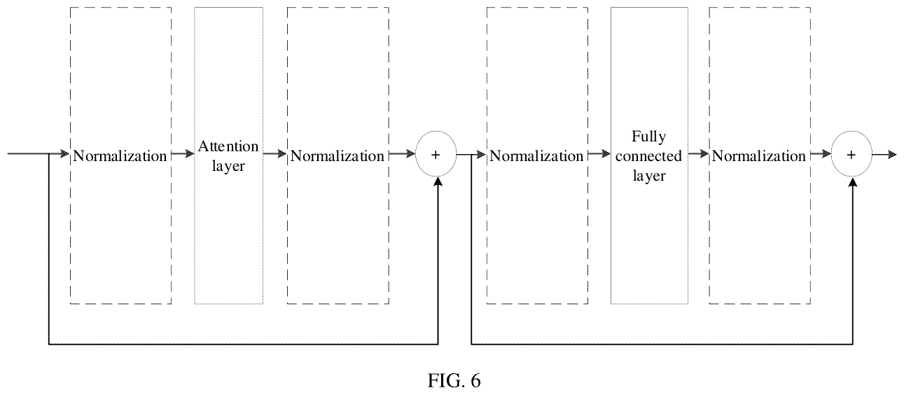

FIG. 6 shows an example of a processing layer. As shown in FIG. 6, a dashed box labeled normalization may represent an optional position for a normalization operation. It can be learned from FIG. 6 that the normalization operation may be set before an attention layer, after the attention layer, before a fully connected layer, and/or after the fully connected layer. It may be understood that the processing layer may include one or more normalization operations. The normalization operation may be normalizing dimensions of a batch of data. In other words, the normalization operation may be performing batch normalization on high-dimensional vectors. Alternatively, the normalization operation may be normalizing dimensions of a group of data. In other words, the normalization operation may be performing layer normalization on high-dimensional vectors. For example, the normalization operation may satisfy Formula (3):

$$y = \frac{x - μ}{\sqrt{σ + ∈}} \times γ + β \qquad Formula ( 3 )$$

x represents an input of the normalization operation, y represents an output of the normalization operation, μ represents a mean value calculated based on x, σ represents a variance calculated based on x, ε represents a preset minimum value for preventing a denominator from being 0, and γ and β are trained parameters.

For example, the normalization operation is before the attention layer and the fully connected layer. An input of a first normalization operation may be N high-dimensional vectors output by an input layer. For the first normalization operation, refer to Formula (3). An output of the first normalization operation may be N normalized high-dimensional vectors. An input of the attention layer may be the output of the first normalization operation. For an operation of the attention layer, refer to Formula (1). The attention layer may process the N high-dimensional vectors. An output of the attention layer may be N high-dimensional vectors. It can be learned from FIG. 6 that an input of a second normalization operation may be the output of the attention layer, and optionally, N high-dimensional vectors. Adding the N high-dimensional vectors to the input of the second normalization operation can speed up convergence and resolve a problem of gradient vanishing. The second normalization operation may be normalizing the N high-dimensional vectors output by the attention layer, and an output of the second normalization operation may be N normalized high-dimensional vectors. A dimension of the output of the normalization operation is the same as a dimension of an output of the fully connected layer. An input of the fully connected layer may be the output of the second normalization operation. For an operation of the fully connected layer, refer to Formula (2). The fully connected layer may process a high-dimensional vector. The output of the fully connected layer may be understood as a high-dimensional vector obtained through processing by using a second model.

It should be noted that, in a second model group, an input of a third normalization operation may be N high-dimensional vectors obtained through processing by using a first model and the second model. By analogy, the processing layer shown in FIG. 6 may be iterated L times.

In another possible case, iterative computation may be stopped based on an actual situation. For example, a convergence condition may be set, for example, an average output error of an l^{th} iteration and an (l+1)th iteration is less than a threshold. l is an integer greater than or equal to 1 and less than L.

In an example, an input and an output of each operation at the processing layer may be considered as a matrix, and the matrix may be (N×dₖ)-dimensional. In this case, the input of the second normalization layer may be a matrix obtained by adding the output of the attention layer and the N high-dimensional vectors. That is, the input of the second normalization operation is still a (N×dₖ)-dimensional matrix.

It should be noted that in this embodiment of this application, each operation of the neural network, for example, the input layer, the second model and the one or more first models at the processing layer, and the output layer, may be set as an operation of a fully connected neural network. An operation of the second model at the processing layer may be applying a self-attention mechanism to outputs of a plurality of fully connected neural networks.

The processing layer is set according to Manner 1, so that an independent transformation of the input signal that is input is implemented. That is, a parameter of the neural network is independent of the dimension of the input signal that is input, so that easy scalability of the neural network is achieved. In addition, extraction of a correlation between any two input signals may be completed through the attention layer, and a larger quantity of parameters can therefore be obtained, so that the neural network can be applied to more communication scenarios.

### Manner 2:

An operation performed by the second model may be based on a first matrix, and an operation performed by the one or more first models may be based on one or more second matrices. In other words, operations of the processing layer may include the operation based on the first matrix and the operation based on the second matrix.

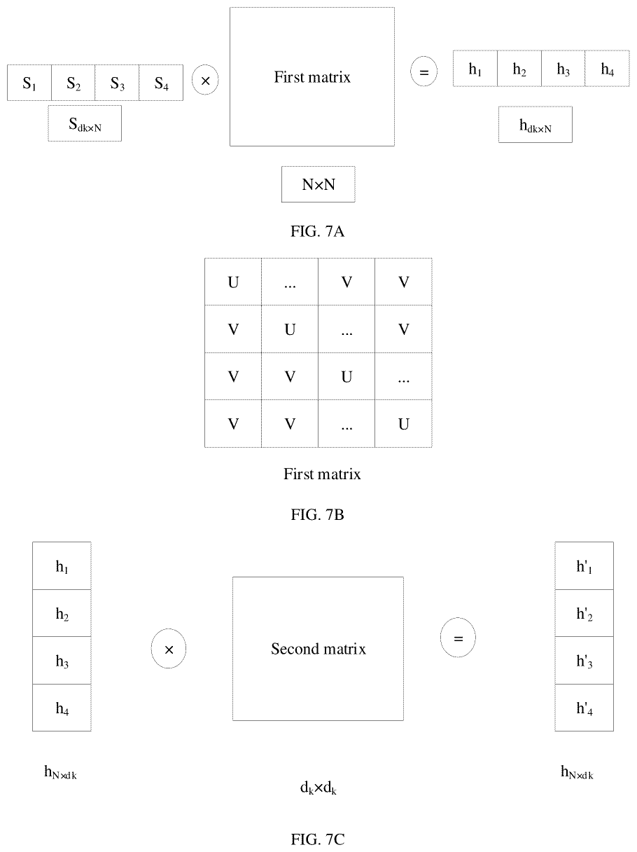

Refer to FIG. 7A. The first matrix may be an N×N matrix.

In a possible case, the first matrix may be a trained matrix. A training manner of the first matrix may be implemented with reference to the foregoing training manner of W^{Q}, W^{K}, and W^{V}. As shown in FIG. 7B, elements on a main diagonal of the first matrix are the same and are U, and elements that are not on the main diagonal are the same and are V. The element U on the main diagonal represents obtaining a feature of the input signal, and the element V that is not on the main diagonal represents obtaining features of an input signal and another input signal. For example, when a dimension of the input high-dimensional vector is 3×dₖ, the first matrix is a 3×3 matrix. In the first matrix, an element in a first row and a first column is U, and the element is used to process a first high-dimensional vector; an element in the first row and a second column is V, and the element is used to process the first high-dimensional vector and a second high-dimensional vector; an element in the first row and a third column is V, and the element is used to process the first high-dimensional vector and a third high-dimensional vector; and so on. The first matrix is an N×N matrix. In other words, a size of the first matrix is extended as a quantity of input high-dimensional vectors increases. Therefore, the first matrix has scalability.

As shown in FIG. 7A, it is assumed that a first output of the second model, namely, a first row of a matrix output by the second model, is h₁=f(S₁U, S₂V, S₃V, S₄V . . . ). f may represent summation, and indicate that S is multiplied by the first matrix. It may be understood that f may alternatively represent calculating a maximum value, a minimum value, an average value, or the like. This is not specifically limited in this application. S may represent the input high-dimensional vectors.

In another possible case, the first matrix is calculated based on the N input high-dimensional vectors. The first matrix may be f(R_{S}), f(C_{S}), f(cos_{S}), or the like, where R_{S} represents an autocorrelation matrix of S, C_{S} represents an autocovariance matrix of S, cos_{S} represents calculating a cosine similarity between every two of the high-dimensional vectors S, and f represents a normalization operation or a non-linear operation. S may represent the input high-dimensional vectors.

In still another possible case, the first matrix may be in a form of fully connected neural network. For example, an output of the second model is h_{S}=f(SW^{S}+b). W^{S} and b are trained parameters, and a training manner may be implemented with reference to the foregoing training manner of W^{Q}, W^{K}, and W^{V}. f represents an activation function. W^{S} may represent a weight, and b may represent a bias.

In this embodiment of this application, b represents a bias of the fully connected neural network. Values of b in different modules may be different, and a value of b is determined based on an actual training result. For example, a value of b in h_{S} may be different from a value of b in Formula (2).

Refer to FIG. 7C. The second matrix may be a dₖ×dₖ matrix. The second matrix may be a trained parameter, and a training manner may be implemented with reference to the foregoing training manner of W^{Q}, W^{K}, and W^{V}. It is assumed that a first output of the one or more first models is h′1=f(h₁ W). f may represent summation, and indicate that h₁ is multiplied by the first matrix, h₁ represents a first output of the second model, and W represents a weight. It may be understood that f may alternatively represent calculating a maximum value, a minimum value, an average value, or the like. This is not specifically limited in this application.

It may be understood that the second matrix may also be extended to a form of fully connected neural network, for example, h′=f(hW+b). W and b are trained parameters, and a training manner may be implemented with reference to the foregoing training manner of W^{Q}, W^{K}, and W^{V}. f represents an activation function.

Optionally, a plurality of first matrices and a plurality of second matrices may alternatively be concatenated in one iteration. In other words, the operation of the second model may be an operation based on the plurality of first matrices, and the operation of the one or more first models may be an operation based on one or more second matrices.

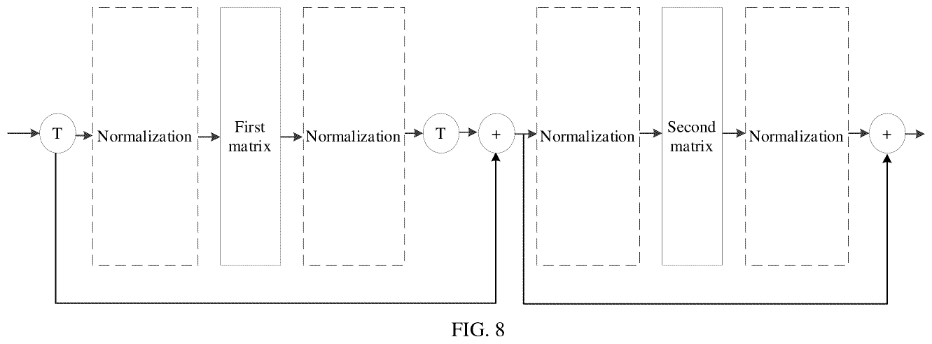

FIG. 8 shows an example of a processing layer. As shown in FIG. 8, a dashed box labeled normalization may represent an optional position for a normalization operation. For setting of the normalization operation, refer to the related descriptions in FIG. 6. Details are not described herein again. As shown in FIG. 8, before a first normalization operation, a matrix transpose operation may be performed on an input high-dimensional vector. This is because an input of the processing layer is (N×dₖ)-dimensional, and a second model performs an operation on the dimension N. Therefore, the matrix transpose operation may be performed on the input high-dimensional vector. In other words, the (N×dₖ)-dimensional high-dimensional vector is transposed to a (dₖ×N)-dimensional high-dimensional vector. Similarly, a matrix transpose operation may be added after an output of the second model. In other words, the matrix transpose operation may be performed on the output of the second model. This is because the output of the second model is (dₖ×N)-dimensional, and one or more first models perform an operation on the dimension dₖ. Therefore, the matrix transpose operation may be performed on the output of the second model. In other words, N (dₖ×N)-dimensional high-dimensional vectors are transposed to (N×dₖ)-dimensional high-dimensional vectors.

The processing layer is set according to Manner 2, so that an independent transformation of the input signal that is input is implemented, and the input signal can be processed through the first matrix and the second matrix. Therefore, easy scalability of the neural network is achieved by extending a size of the matrix. In addition, a correlation between any two input signals may be extracted through the first matrix, and a larger quantity of parameters can therefore be obtained, so that the neural network can be applied to more communication scenarios.

### Manner 3:

In Manner 3, an operation of the processing layer may be an operation of a graph neural network. The following provides example descriptions.

An input of the graph neural network may be a high-dimensional vector

$${S}_{N \times {d}_{k}} = \{ {S}_{1}^{0} , {S}_{2}^{0} , … , {S}_{N}^{0} \} .$$

0 in

$${S}_{N}^{0}$$

may represent an initial state of the high-dimensional vector. A communication apparatus may use each high-dimensional vector as a node in the graph neural network. In other words, the graph neural network may have N nodes. In other words, the communication apparatus may set each high-dimensional vector to an initial state of the node in the graph neural network, for example, a state of a 0^{th} iteration. One high-dimensional vector may correspond to one node. In the graph neural network, the second model and the one or more first models are not explicitly distinguished in structure, and the second model and the one or more first models are distinguished in operation steps of the graph neural network.

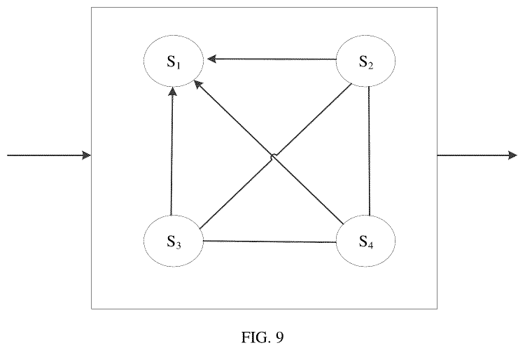

FIG. 9 shows an example of a processing layer according to an embodiment of this application. In FIGS. 9, S₁, S₂, S₃, and S₄ may be nodes of a graph neural network. An operation of a second model may be that the S_{N} obtains an aggregated state of another adjacent node. S_{N} represents any node of the graph neural network. For example, S₁ may obtain aggregated states of S₂, S₃, and S₄. The operation of the second model may satisfy Formula (4):

$${S}_{𝒩 ( v )}^{K} = {AGGREGATE}_{K} ( {S}_{u}^{K - 1} , ∀ u ∈ 𝒩 ( v ) ) \qquad Formula ( 4 )$$

An aggregate function (AGGREGATE) may be calculating a maximum value, a minimum value, an average value, a sum, or the like.

In Formula (4), Z represents a quantity of iterations, [symbol] (v) represents another node adjacent to a node v,

$${S}_{N ( v )}^{K}$$

represents an aggregated state of the another node adjacent to the node v in a Z^{th} iteration, and

$${S}_{u}^{K - 1}$$

represents a status of the another node adjacent to the node v in a (Z−1)^{th} iteration, where Z is an integer greater than or equal to 1. Z may represent a preset quantity of iterations. It may be understood that a status of the node at a 0^{th} iteration may be a high-dimensional vector corresponding to the node.

An operation of one or more first models may be that S_{N} updates a status of S_{N} based on an aggregated state of another adjacent node in a Z^{th} iteration and a status of S_{N} in the Z^{th} iteration. The operation of the one or more first models may satisfy Formula (5):

$${S}_{v}^{K} = σ ( {w}^{K} \cdot concat ( {S}_{v}^{K - 1} , {S}_{N ( v )}^{K} ) ) \qquad Formula ( 5 )$$

σ represents an activation function, and Z represents a quantity of iterations, where Z is an integer greater than or equal to 1. Z may represent a preset quantity of iterations, w^{K} represents a weight of the Z^{th} iteration,

$${S}_{v}^{K - 1}$$

represents a status of the node v in a (Z−1)^{th} iteration,

$${s}_{N ( v )}^{K}$$

represents an aggregated state of the another node adjacent to the node v in the Z^{th} iteration, and a concatenate function (concat) may represent concatenation. In other words,

$${S}_{N ( v )}^{K} and {S}_{v}^{K - 1}$$

are concatenated. It may be understood that the concatenation may be understood as splicing two vectors into one vector.

Through K iterations, the graph neural network may output a status of each node at the Z^{th} iteration and an aggregated state that is of an adjacent node and that is obtained by each node at the Z^{th} iteration. It may be understood that a dimension of the status of each node at the Z^{th} iteration and the aggregated state that is of the adjacent node and that is obtained by each node at the Z^{th} iteration that are output by each node is dₖ, and a dimension of the status of each node at the Z^{th} iteration and the aggregated state that is of the adjacent node that is obtained by each node at the Z^{th} iteration that are output by N nodes is N×dₖ. The status of each node at the Z^{th} iteration may be understood as a high-dimensional vector optimized through the first model. The aggregated state that is of the adjacent node and that is obtained by each node at the Z^{th} iteration may be understood as a high-dimensional vector optimized through the second model.

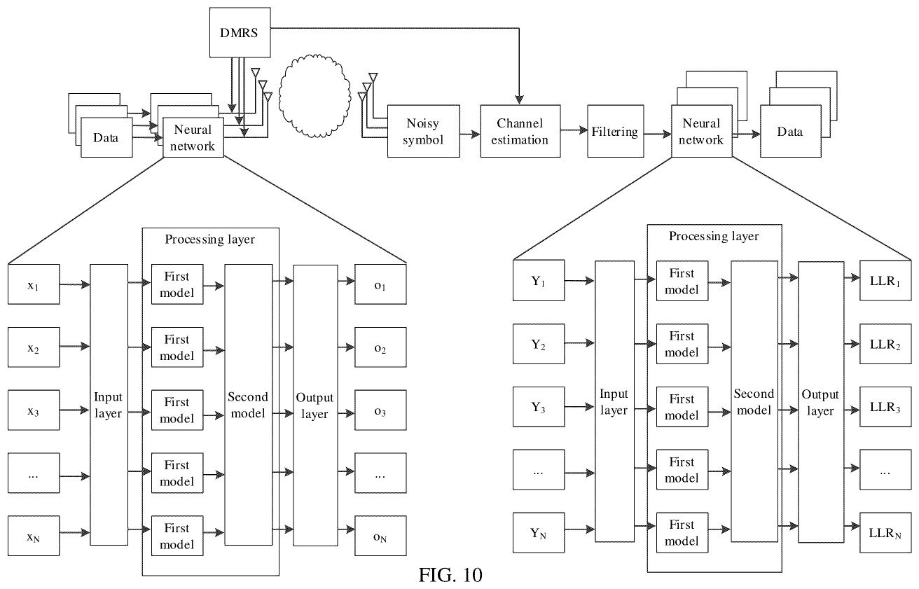

The data processing manner of the base station or the terminal in embodiments of this application is described with reference to FIG. 10 Refer to FIG. 10. The base station may input data to a neural network, and a processing layer of the neural network may include a first model and a second model. The base station may obtain an output signal based on the neural network. A processing manner in which the base station obtains the output signal may be implemented with reference to the embodiment shown in FIG. 3. Details are not described herein again. The base station may send the output signal through an air interface (Uu). Optionally, the base station may perform operations such as layer mapping, port mapping and DMRS symbol insertion, precoding, and orthogonal frequency division multiplexing (OFDM) technology generation on the output signal, and then send the output signal through the air interface.

The terminal may receive the output signal sent by the base station, and input the output signal to the neural network, to obtain second data. A processing manner in which the terminal obtains the output signal may be implemented with reference to the embodiment shown in FIG. 3. Details are not described herein again. Optionally, the terminal may perform operations such as OFDM waveform demodulation and physical resource demapping on the output signal, and then input the output signal to the neural network. Optionally, the second data may be a log-likelihood ratio, and the terminal may perform a decoding operation on the log-likelihood ratio output by the neural network, to obtain an information bit.

If the output signal of the base station includes a DMRS, the terminal may perform channel estimation and channel equalization based on the DMRS, and the terminal may input a channel estimation result and a channel equalization result to the neural network, to obtain a channel estimation result and a channel equalization result with better performance.

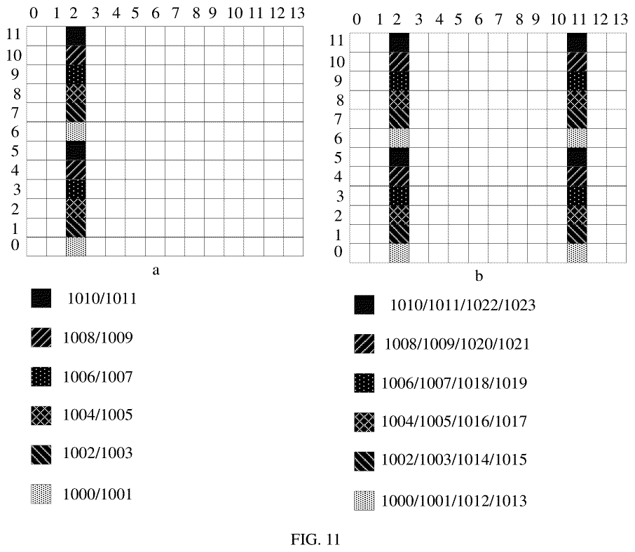

It may be understood that the DMRS in embodiments of this application may be a sparse and frequency-domain scattered DMRS, as shown in FIG. 11. In FIG. 11, resources of a same color employ code division multiplexing for a plurality of ports, and each port occupies one resource element (RE)/resource block (RB). For such a sparse and frequency-domain scattered DMRS, RE/RB occupation can be reduced, saving resources. However, because the channel estimation result or the channel equalization result obtained based on the DMRS is poor, the channel estimation result and the channel equalization result of the terminal may be input to the neural network to improve performance.

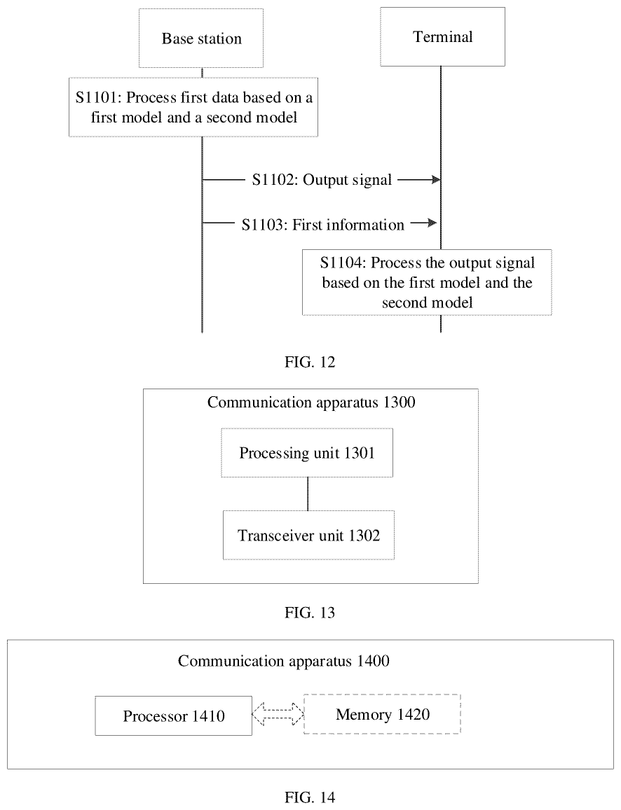

The following describes, based on the accompanying drawings, the information transmission method provided in embodiments of this application. FIG. 12 is an example flowchart of an information transmission method according to an embodiment of this application. The method may include the following operations.
S1101: A base station processes first data based on a first model and a second model to obtain an output signal.

For example, the base station may process the first data in the manner shown in FIG. 3 to obtain the output signal. When the base station processes the first data in the manner shown in FIG. 3, the input signal in FIG. 3 may be the first data.
S1102: The base station sends an output signal to a terminal.

Correspondingly, the terminal may receive the output signal sent by the base station.

It may be understood that the output signal sent by the base station in S1102 may be an output of the foregoing neural network, or may be a signal obtained by processing the output of the neural network, for example, a signal obtained through DMRS insertion, precoding, and OFDM waveform generation.
S1103: The base station sends first information to the terminal.

Correspondingly, the terminal receives the first information from the base station.

The first information may indicate the first model and the second model.
S1104: The terminal processes the output signal based on the first model and the second model, to obtain second data.

For example, the terminal may process the output signal in the manner shown in FIG. 3 to obtain the second data. When the terminal processes the output signal in the manner shown in FIG. 3, the input signal in FIG. 3 may be the output signal, and the output signal in FIG. 3 may be the second data.

In a possible implementation, the base station and the terminal may be configured with a plurality of pre-trained models, for example, a plurality of first models and a plurality of second models, to adapt to a plurality of channel statuses or scenarios. In a possible case, the base station may determine the first model and the second model based on the channel status. For example, the base station may send a downlink reference signal, for example, a channel state information (CSI)-reference signal (RS). The terminal may measure the received CSI-RS to obtain CSI, including, for example, a channel quality indicator (CQI), a rank indicator (RI), and a precoding indicator (PMI). The terminal may feed back the CSI to the base station. In this way, the base station may determine the first model and the second model based on the CSI reported by the terminal.

For another example, the terminal may send an uplink sounding reference signal (SRS), and the base station may measure the received SRS to determine the channel status. For example, the base station may measure a signal to interference plus noise ratio (SNR), reference signal received power (RSRP), reference signal received quality (RSRQ), or the like of the SRS. In this way, the base station may determine the first model and the second model based on a measurement result of the SRS.

The CSI or the measurement result of the SRS may be used to determine the channel status, so that the channel status can correspond to the first model and the second model. For example, the base station and the terminal may be configured with a correspondence between a first model and a channel status and a correspondence between a second model and a channel status. The correspondence between a first model and a channel status may be many-to-one. In other words, a plurality of first models may correspond to one channel status. Alternatively, the correspondence between a first model and a channel status may be one-to-many. In other words, one first model may correspond to a plurality of channel statuses. Alternatively, the correspondence between a first model and a channel status may be one-to-one. In other words, one first model may correspond to one channel status. Similarly, the correspondence between a second model and a channel status may be many-to-one, one-to-many, or one-to-one.

In another possible case, the first model and/or the second model may be determined based on the scenario, for example, a time-frequency domain resource, a throughput rate, a peak to average power ratio (PAPR), an adjacent channel leakage ratio (ACLR), phase-noise suppression, or terminal mobility. For example, different time-frequency domain resources may correspond to different first models and/or second models. For another example, a high throughput rate and a low throughput rate may correspond to different first models and/or second models. For another example, different PAPRs may correspond to different first models and/or second models. For example, a low PAPR and a high PAPR may correspond to different first models and/or second models. For another example, terminals with different mobility may correspond to different first models and/or second models. For example, a terminal with high mobility and a terminal with low mobility may correspond to different first models and/or second models.

In the foregoing solution, the base station may determine the first model and the second model based on the channel status or the scenario, to indicate, to the terminal based on the first information, the first model and the second model that are used for data processing.

In a possible implementation, the first information may indicate a structure of the first model and a structure of the second model. For example, the first information may indicate information such as a quantity of layers of the first model and a quantity of layers of the second model, a quantity of nodes at each layer, a connection relationship between nodes at each layer, a connection relationship between layers, and a weight of each node, to indicate the structure of the first model and the structure of the second model to the terminal.

In another possible implementation, the first information may indicate an index of the first model and an index of the second model. For example, the terminal and the base station may be preconfigured with a plurality of first models and a plurality of second models, and allocate an index to each first model and an index to each second model. In this way, the first information may indicate the index of the first model and the index of the second model. The terminal may determine, based on the index of the first model, the corresponding first model, and determine, based on the index of the second model, the corresponding second model.

The following describes an implementation in which the first information indicates the index of the first model and the index of the second model.
Case 1: Add a new field to signaling to carry the first information, to indicate the index of the first model and the index of the second model.

For example, a new field may be added to downlink channel control information (downlink control information, DCI), radio resource control (RRC) signaling, or other control signaling to carry the first information. For ease of differentiation, a field indicating the index of the first model is referred to as a local processing module index (single input single output block index, SBI), and a field indicating the index of the second model is referred to as a global processing module index (CBI).

An example in which a new SBI and a new CBI are added to the DCI is used. Formats of the newly added fields in the DCI may be shown in Table 1.

TABLE 1
Example of formats of an SBI and a CBI in DCI

| Field | Quantity of bits | Meaning |
|---|---|---|
| SBI | 3, 4, 6 | Index of one or more first models |
| CBI | 4, 6 | Index of one or more second models |

The SBI may be shown in Table 2, and the CBI may be shown in Table 4.

TABLE 2
Example of an SBI configuration table

| Value | Index | Correlation (reference) |
|---|---|---|
| 0 | 0 | |
| 1 | 1 | |
| 2 | 2 | |
| . . . | . . . | |

In the example shown in Table 2, the SBI may be 3 bits, 4 bits, or 6 bits, and may indicate the index of the first model, for example, the index of the one or more first models.

In a possible case, in a MIMO scenario, the SBI provided in this embodiment of this application may indicate a quantity of transmit streams, as shown in Table 3.

TABLE 3
Example of an SBI configuration table

| | Quantity of transmit streams | | |
|---|---|---|---|
| Value | (number of tx layers) | Index | Meaning |
| 0 | 2 | 0, 8 | A first model |
| | | | whose index is |
| | | | “0” and a first |
| | | | model whose |
| | | | index is “8” |
| 1 | 2 | 0, 12 | The first model |
| | | | whose index is |
| | | | “0” and a first |
| | | | model whose |
| | | | index is “12” |
| 2 | 2 | 0, 15 | The first model |
| | | | whose index is |
| | | | “0” and a first |
| | | | model whose |
| | | | index is “15” |
| . . . | | . . . | |
| | . . . | | |

As shown in Table 3, when a value of the SBI is “0”, it may indicate that the quantity of transmit streams is 2, and indicate the model whose index is “0” and the model whose index is “8”. Optionally, in this case, one model may process a data stream of one layer. For example, the model whose index is “0” may be configured to process a data stream of a first layer and the first model whose index is “8” may be configured to process a data stream of a second layer, or the model whose index is “8” may be configured to process the data stream of the first layer and the first model whose index is “0” may be configured to process the data stream of the second layer, and so on.

TABLE 4
Example of a CBI configuration table

| Value | Index |
|---|---|
| 0 | 0 |
| 1 | 1 |
| 2 | 2 |
| 3 | 3 |
| 4 | . . . |

In the example shown in Table 4, the CBI may indicate the index of the second model.

In a possible case, the second model may correspond to the quantity of transmit streams in the MIMO scenario, and different second models may be allocated based on a correlation relationship between layers, as shown in Table 5.

TABLE 5
Example of a CBI configuration table

| | | Quantity of transmit streams | Correlation |
|---|---|---|---|
| Value | Index | (number of tx layers) | (reference) |
| 0 | 0 | 1 | |
| 1 | 1 | 2 | High correlation |
| 2 | 2 | 2 | Medium correlation |
| 3 | 3 | 2 | Low/Un correlation |
| 4 | . . . | . . . | . . . |

As shown in Table 5, when the quantity of transmit streams is 1, the base station may use a second model whose index is “0”, and indicate the second model to the terminal by using the CBI. For another example, when the quantity of transmit streams is 2 and a correlation between layers is high, the base station may use a second model whose index is “1”, and indicate the second model to the terminal by using the CBI, and so on.

Optionally, in this embodiment of this application, the output signal sent by the base station to the terminal may include a DMRS or may not include a DMRS. The first information may further indicate whether the output signal includes the DMRS. For example, the SBI may indicate whether the output signal includes the DMRS. For another example, the CBI may indicate whether the output signal includes the DMRS.

Similarly, an example in which a new SBI and a new CBI are added to the DCI is used. Formats of the newly added fields in the DCI may be shown in Table 6.

TABLE 6
Example of formats of an SBI and a CBI in DCI

| Field | Quantity of bits | Meaning |
|---|---|---|
| SBI | 3, 4, 6 | Index of one or more first |
| | | models and whether a |
| | | DMRS is included |
| CBI | 4, 6 | Index of one or more second |
| | | models and whether a |
| | | DMRS is included |

As shown in Table 6, the SBI and/or the CBI may indicate whether the output signal includes the DMRS. If the SBI indicates whether the output signal includes the DMRS, the SBI may be shown in Table 7.

TABLE 7
Example of an SBI configuration table

| Value | Index | Correlation (reference) |
|---|---|---|
| 0 | 0 | With a DMRS/Without a DMRS |
| 1 | 1 | With a DMRS/Without a DMRS |
| 2 | 2 | With a DMRS/Without a DMRS |
| . . . | . . . | |

As shown in Table 7, the SBI may indicate whether the DMRS exists in the output signal.

If the CBI indicates whether the output signal includes the DMRS, the CBI may be shown in Table 8.

TABLE 8
Example of a CBI configuration table

| Value | Index | Correlation (reference) |
|---|---|---|
| 0 | 0 | With a DMRS/Without a DMRS |
| 1 | 1 | With a DMRS/Without a DMRS |
| 2 | 2 | With a DMRS/Without a DMRS |
| 3 | 3 | |
| 4 | . . . | |

As shown in Table 8, the CBI may indicate whether the DMRS exists in the output signal.

According to the foregoing solution, the SBI and the CBI may indicate the index of the first model and the index of the second model, and optionally, may indicate the quantity of transmit streams and whether the DMRS exists.

It may be understood that the SBI and the CBI may be two different fields. A person skilled in the art may design the SBI and the CBI as one field to jointly indicate the index of the first model and the index of the second model. For example, first x bits of a field indicate the index of the first model, and remaining bits indicate the index of the second model. This is not specifically limited in this application.
Case 2: Reuse an existing field in signaling to carry the first information, to indicate the index of the first model and the index of the second model.

For example, a reserved field in the signaling may be used to carry the first information, to indicate the index of the first model and the index of the second model.

For another example, an antenna port field in DCI may indicate the index of the first model and/or the index of the second model. For example, the antenna port may correspond to the first model and/or the second model, so that the antenna port field indicates the index of the first model and/or the index of the second model when indicating an antenna port number.

For another example, different fields may be reused to carry the first information, to jointly indicate the index of the first model and the index of the second model. For example, the antenna port field in the DCI may be 4 bits. Therefore, the antenna port field may indicate the index of the first model jointly with a part of bits of another field, for example, a reserved field or a channel characteristic indication field. The channel characteristic indication field is used as an example. In a related technology, the channel characteristic indication field may indicate a channel status, for example, the channel status described above, and may be 6 bits. For example, the index of the first model may be indicated by using the 4 bits of the antenna port field and 2 bits, for example, first 2 bits or last 2 bits, of the channel status indication. The index of the second model is indicated by using remaining bits of the channel status indication.

Optionally, in Case 2, the first information may indicate whether a DMRS exists, and optionally, may indicate a quantity of transmit streams. Refer to Case 1 for implementation. Details are not described herein again.

It should be noted that the name of the foregoing field and a quantity of bits of the field are merely examples. A person skilled in the art may change the name and the quantity of bits of the field to indicate the index of the first model and the index of the second model. This is not specifically limited in this application.

In a possible case, after measurement of a reference signal ends, for example, after measurement of the SRS ends or after the terminal sends the CSI to the base station, the base station may send the DCI to the terminal. Therefore, the DCI may carry the first information. In another possible case, the first information may alternatively be carried in an RRC configuration message or an RRC reconfiguration message. This is not specifically limited in this application.

In this embodiment of this application, if a processing layer of the neural network further includes a third model, the base station may send second information to the terminal, to indicate the third model, for example, indicate a structure of the third model or indicate an index of the third model. An implementation of the second information may be implemented with reference to the first information. Optionally, the second information may alternatively be carried in the first information.

Based on a concept of the foregoing embodiments, refer to FIG. 13. An embodiment of this application provides a communication apparatus 1300. The apparatus 1300 includes a processing unit 1301 and a transceiver unit 1302. The apparatus 1300 may be a communication apparatus, or may be an apparatus that is used in a communication apparatus and that can support the communication apparatus in performing a signal processing method.

The transceiver unit may also be referred to as a transceiver module, a transceiver, a transceiver device, a transceiver apparatus, or the like. The processing unit may also be referred to as a processor, a processing board, a processing unit, a processing apparatus, or the like. Optionally, a component that is in the transceiver unit and that is configured to implement a receiving function may be considered as a receiving unit. It should be understood that the transceiver unit is configured to perform a sending operation and a receiving operation of the communication apparatus in the foregoing method embodiments, and a component that is in the transceiver unit and that is configured to implement a sending function is considered as a sending unit. That is, the transceiver unit includes the receiving unit and the sending unit.

In addition, it should be noted that, if the apparatus is implemented by using a chip/chip circuit, the transceiver unit may be an input/output circuit and/or a communication interface, and perform an input operation (corresponding to the foregoing receiving operation) and an output operation (corresponding to the foregoing sending operation). The processing unit is an integrated processor, a microprocessor, or an integrated circuit.

The following describes in detail an implementation in which the apparatus 1300 is used in a terminal device and a network device.

For example, operations performed by the units of the apparatus 1300 when the apparatus 1300 is used in the terminal device are described in detail.

In an optional implementation, the communication apparatus 1300 may be used in the terminal device to perform the method performed by the foregoing terminal device, for example, the method performed by the terminal device in the embodiment shown in FIG. 12. The transceiver unit 1302 is configured to receive first information from the network device, where the first information indicates a first model for performing local data processing and a second model for performing global data processing. The transceiver unit 1302 is further configured to receive an output signal from the network device. The output signal is data processed through the first model and the second model. The processing unit 1301 is configured to process the output signal based on the first model and the second model to obtain second data.

For example, operations performed by the units of the apparatus 1300 when the apparatus 1300 is used in the network device are described in detail.

In an optional implementation, the communication apparatus 1300 may be used in the network device to perform the method performed by the foregoing network device, for example, the method performed by the network device in the embodiment shown in FIG. 12. The transceiver unit 1302 is configured to send first information to the terminal device, where the first information indicates a first model for performing local data processing and a second model for performing global data processing. The processing unit 1301 is configured to process data based on the first model and the second model to obtain an output signal. The transceiver unit 1302 is further configured to send the output signal to the terminal device.

Based on a concept of embodiments, as shown in FIG. 14, an embodiment of this application provides a communication apparatus 1400. The communication apparatus 1400 includes a processor 1410. Optionally, the communication apparatus 1400 may further include a memory 1420 configured to store instructions executed by the processor 1410, store input data for the processor 1410 to run the instructions, or store data generated after the processor 1410 runs the instructions. The processor 1410 may implement the method shown in the foregoing method embodiments based on the instructions stored in the memory 1420.

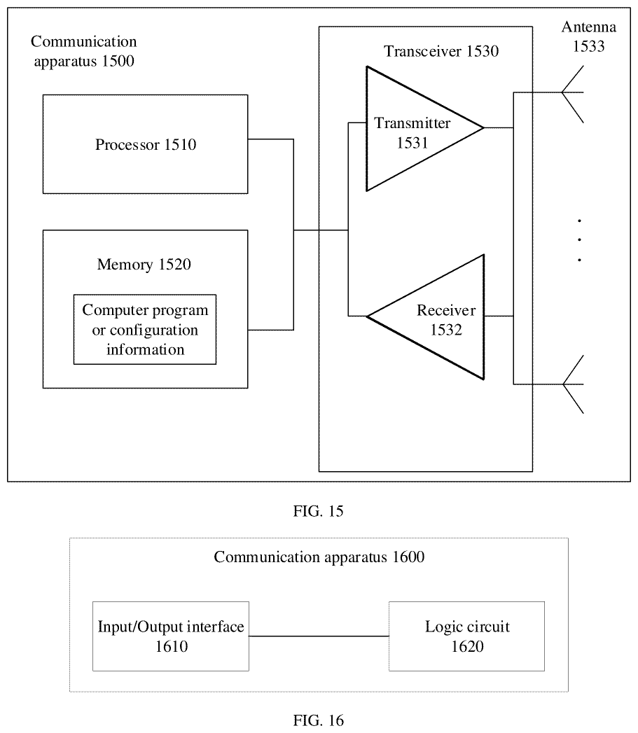

Based on a concept of embodiments, as shown in FIG. 15, an embodiment of this application provides a communication apparatus 1500. The communication apparatus 1500 may be a chip or a chip system. Optionally, in this embodiment of this application, the chip system may include a chip, or may include a chip and another discrete component.

The communication apparatus 1500 may include at least one processor 1510. The processor 1510 is coupled to a memory. Optionally, the memory may be located inside the apparatus, or may be located outside the apparatus. For example, the communication apparatus 1500 may further include at least one memory 1520. The memory 1520 stores a computer program, configuration information, a computer program or instructions, and/or data for implementing any one of the foregoing embodiments. The processor 1510 may execute the computer program stored in the memory 1520, to complete the method in any one of the foregoing embodiments. Optionally, the memory may be integrated with the processor.

The coupling in this embodiment of this application may be an indirect coupling or a communication connection between apparatuses, units, or modules in an electrical form, a mechanical form, or another form, and is used for information exchange between the apparatuses, the units, or the modules. The processor 1510 may cooperate with the memory 1520. A specific connection medium between a transceiver 1530, the processor 1510, and the memory 1520 is not limited in this embodiment of this application.

The communication apparatus 1500 may further include the transceiver 1530, and the communication apparatus 1500 may exchange information with another device through the transceiver 1530. The transceiver 1530 may be a circuit, a bus, a transceiver, or any other apparatus that may be configured to exchange information, or is referred to as a signal transceiver unit. As shown in FIG. 15, the transceiver 1530 includes a transmitter 1531, a receiver 1532, and an antenna 1533. In addition, when the communication apparatus 1500 is a chip-type apparatus or a circuit, the transceiver in the communication apparatus 1500 may alternatively be an input/output circuit and/or a communication interface, and may input data (or receive data) and output data (or send data). The processor is an integrated processor, a microprocessor, or an integrated circuit, and the processor may determine output data based on input data.

In a possible implementation, the communication apparatus 1500 may be used in a communication apparatus. The communication apparatus 1500 may be a communication apparatus, or may be an apparatus that can support a communication apparatus in implementing functions of the terminal device or the network device in any one of the foregoing embodiments. The memory 1520 stores a computer program, a computer program or instructions, and/or data for implementing the functions of the terminal device or the network device in any one of the foregoing embodiments. The processor 1510 may execute the computer program stored in the memory 1520, to complete the method performed by the terminal device or the network device in any one of the foregoing embodiments.

The communication apparatus 1500 provided in this embodiment may be used in the terminal device or the network device, to complete the method performed by the terminal device or the network device. Therefore, for technical effects that can be achieved by the communication apparatus, refer to the foregoing method embodiments. Details are not described herein again.

In embodiments of this application, the processor may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module.

In embodiments of this application, the memory may be a non-volatile memory, for example, a hard disk drive (HDD) or a solid-state drive (SSD), or may be a volatile memory, for example, a random access memory (RAM). The memory may alternatively be any other medium that can be configured to carry or store expected program code in a form of instruction or data structure and that can be accessed by a computer, but is not limited thereto. The memory in embodiments of this application may alternatively be a circuit or any other apparatus that can implement a storage function, and is configured to store a computer program, a computer program or instructions, and/or data.

Refer to FIG. 16. Based on the foregoing embodiments, an embodiment of this application further provides another communication apparatus 1600, including an input/output interface 1610 and a logic circuit 1620. The input/output interface 1610 is configured to receive code instructions and transmit the code instructions to the logic circuit 1620. The logic circuit 1620 is configured to run the code instructions to perform the method performed by the network device or the terminal device in any one of the foregoing embodiments.

The following describes in detail an operation performed by the apparatus 1600 when the apparatus 1600 is used in the terminal device or the network device.

In an optional implementation, the communication apparatus 1600 may be used in the terminal device, to perform the method performed by the terminal device, for example, the method performed by the terminal device in the embodiment shown in FIG. 12. The input/output interface 1610 is configured to input first information from the network device, where the first information indicates a first model for performing local data processing and a second model for performing global data processing. The input/output interface 1610 is further configured to input an output signal from the network device. The output signal is data processed through the first model and the second model. The logic circuit 1620 is configured to process the output signal based on the first model and the second model to obtain second data.

In an optional implementation, the communication apparatus 1600 may be used in the network device, to perform the method performed by the network device, for example, the method performed by the network device in the embodiment shown in FIG. 12. The input/output interface 1610 is configured to output first information to the terminal device, where the first information indicates a first model for performing local data processing and a second model for performing global data processing. The logic circuit 1620 is configured to process data based on the first model and the second model to obtain an output signal. The input/output interface 1610 is further configured to output the output signal to the terminal device.

The communication apparatus 1600 provided in this embodiment may be used in the terminal device or the network device, to perform the method performed by the terminal device or the network device. Therefore, for technical effects that can be achieved by the communication apparatus, refer to the foregoing method embodiments. Details are not described herein again.

Based on the foregoing embodiments, an embodiment of this application further provides a communication system. The system includes at least one terminal device and at least one network device. For technical effects that can be achieved, refer to the foregoing method embodiments. Details are not described herein again.

Based on the foregoing embodiments, an embodiment of this application further provides a computer-readable storage medium. The computer-readable storage medium stores a computer program or instructions. When the instructions are executed, the method performed by the communication apparatus in any one of the foregoing embodiments is implemented. The computer-readable storage medium may include any medium that can store program code, for example, a USB flash drive, a removable hard disk, a read-only memory, a random access memory, a magnetic disk, or an optical disc.

To implement the functions of the communication apparatuses in FIG. 13 to FIG. 16, an embodiment of this application further provides a chip, including a processor, configured to support the communication apparatus in implementing the functions of the terminal device or the network device in the foregoing method embodiments. In a possible design, the chip is connected to a memory, or the chip includes a memory. The memory is configured to store a computer program or instructions and data that are for the terminal device or the network device.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to embodiments of this application. t should be understood that a computer program or instructions may be used to implement each procedure and/or each block in the flowcharts and/or the block diagrams and a combination of a procedure and/or a block in the flowcharts and/or the block diagrams. The computer program or the instructions may be provided for a general-purpose computer, a dedicated computer, an embedded processor, or a processor of another programmable data processing device to generate a machine, so that the instructions executed by the computer or the processor of another programmable data processing device generate an apparatus for implementing a specified function in one or more procedures in the flowcharts and/or in one or more blocks in the block diagrams.

The computer program or the instructions may alternatively be stored in a computer-readable memory that can indicate the computer or the another programmable data processing device to work in a specified manner, so that the instructions stored in the computer-readable memory generate an artifact that includes an instruction apparatus. The instruction apparatus implements a specified function in one or more procedures in the flowcharts and/or in one or more blocks in the block diagrams.

The computer program or the instructions may alternatively be loaded onto the computer or the another programmable data processing device, so that a series of operation steps are performed on the computer or the another programmable device to generate computer-implemented processing. Therefore, the instructions executed on the computer or the another programmable device provide steps for implementing a specified function in one or more procedures in the flowcharts and/or in one or more blocks in the block diagrams.

Clearly, a person skilled in the art may make various modifications and variations to embodiments of this application without departing from the scope of embodiments of this application. In this case, this application is intended to cover these modifications and variations of embodiments of this application provided that they fall within the scope of protection defined by the claims of this application and their equivalent technologies.

1. An information transmission method, comprising:
receiving first information from a first apparatus, wherein the first information indicates a first model for performing local data processing and a second model for performing global data processing;
receiving an output signal from the first apparatus, wherein the output signal is obtained by the first apparatus by processing first data through the first model and the second model; and
processing the output signal based on the first model and the second model to obtain second data.

2. The information transmission method according to claim 1, further comprising:
receiving a downlink reference signal from the first apparatus;
measuring the downlink reference signal to obtain measurement information of the downlink reference signal, wherein the measurement information of the downlink reference signal is used to determine the first model and the second model; and
sending the measurement information of the downlink reference signal to the first apparatus.

3. The information transmission method according to claim 1, further comprising:
sending an uplink reference signal to the first apparatus, wherein the uplink reference signal is used by the first apparatus to measure the uplink reference signal, to obtain measurement information of the uplink reference signal; and
the measurement information of the uplink reference signal is used to determine the first model and the second model.

4. The information transmission method according to claim 1, wherein the first information indicates an index of one or more first models, and the first information further indicates an index of the second model.

5. The information transmission method according to claim 1, wherein the first information comprises an antenna port field and a channel characteristic indication field, and the antenna port field and the channel characteristic indication field indicate the first model and the second model.

6. The information transmission method according to claim 1, wherein processing the output signal based on the first model and the second model to obtain the second data comprises:
inputting the output signal to an input layer of a neural network for dimension increase processing to obtain N1 high-dimensional vectors;
processing the N1 high-dimensional vectors through the first model, to obtain N2 high-dimensional vectors, wherein a manner of processing the N1 high-dimensional vectors through the first model is pre-trained;
processing the N2 high-dimensional vectors through the second model, to obtain N3 high-dimensional vectors, wherein a manner of processing the N2 high-dimensional vectors through the second model is pre-trained; and
inputting the N3 high-dimensional vectors to an output layer of the neural network to obtain the second data.

7. The information transmission method according to claim 6, wherein inputting the output signal to the input layer of the neural network for dimension increase processing to obtain the N1 high-dimensional vectors comprises:
inputting an output signal corresponding to M data streams to the input layer for dimension increase processing, to obtain the N1 high-dimensional vectors, wherein one high-dimensional vector corresponds to one data stream.

8. The information transmission method according to claim 6, wherein the output signal comprises a modulation symbol, a waveform signal, an air interface data symbol, an air interface pilot symbol, or a filtered air interface symbol.

9. An information transmission method, comprising:
sending first information to a second apparatus, wherein the first information indicates a first model for performing local data processing and a second model for performing global data processing;
processing first data based on the first model and the second model to obtain an output signal; and
sending the output signal to the second apparatus.

10. The information transmission method according to claim 9, further comprising:
sending a downlink reference signal to the second apparatus; and
receiving measurement information of the downlink reference signal from the second apparatus, wherein the measurement information of the downlink reference signal is measured by the second apparatus based on the downlink reference signal, and the measurement information of the downlink reference signal is used to determine the first model and the second model.

11. The information transmission method according to claim 9, further comprising:
receiving an uplink reference signal from the second apparatus; and
measuring the uplink reference signal to obtain measurement information of the uplink reference signal, wherein the measurement information of the uplink reference signal is used to determine the first model and the second model.

12. The information transmission method according to claim 9, wherein the first information indicates an index of one or more first models, and the first information further indicates an index of the second model.

13. The information transmission method according to claim 9, wherein the first information comprises an antenna port field and a channel characteristic indication field, and the antenna port field and the channel characteristic indication field indicate the first model and the second model.

14. The information transmission method according to claim 10, wherein processing the first data based on the first model and the second model to obtain the output signal comprises:
inputting the first data to an input layer of a neural network for dimension increase processing to obtain N1 high-dimensional vectors;
processing the N1 high-dimensional vectors through the first model, to obtain N2 high-dimensional vectors, wherein a manner of processing the N1 high-dimensional vectors through the first model is pre-trained;
processing the N2 high-dimensional vectors through the second model, to obtain N3 high-dimensional vectors, wherein a manner of processing the N2 high-dimensional vectors through the second model is pre-trained; and
inputting the N3 high-dimensional vectors to an output layer of the neural network to obtain the output signal.

15. The information transmission method according to claim 14, wherein inputting the first data to the input layer of the neural network for dimension increase processing to obtain the N1 high-dimensional vectors comprises:
inputting the first data corresponding to M data streams to the input layer for dimension increase processing, to obtain the N1 high-dimensional vectors, wherein one high-dimensional vector corresponds to one data stream.

16. A communication apparatus, comprising:
at least one processor configured to execute instructions to cause the communication apparatus to:
receive first information from a first apparatus, wherein the first information indicates a first model for performing local data processing and a second model for performing global data processing;
receive an output signal from the first apparatus, wherein the output signal is obtained by the first apparatus by processing first data through the first model and the second model; and
process the output signal based on the first model and the second model to obtain second data.

17. The communication apparatus according to claim 16, wherein the communication apparatus is further caused to:
receive a downlink reference signal from the first apparatus;
measure the downlink reference signal to obtain measurement information of the downlink reference signal, wherein the measurement information of the downlink reference signal is used to determine the first model and the second model; and
send the measurement information of the downlink reference signal to the first apparatus.

18. The communication apparatus according to claim 16, wherein the communication apparatus is further caused to:
send an uplink reference signal to the first apparatus, wherein the uplink reference signal is used by the first apparatus to measure the uplink reference signal, to obtain measurement information of the uplink reference signal; and
the measurement information of the uplink reference signal is used to determine the first model and the second model.

19. The communication apparatus according to claim 16, wherein the first information indicates an index of one or more first models, and the first information further indicates an index of the second model.

20. The communication apparatus according to claim 16, wherein the first information comprises an antenna port field and a channel characteristic indication field, and the antenna port field and the channel characteristic indication field indicate the first model and the second model.
